(19) United States
(12) Patent Application Publication
(10) Pub. No.: US 2023/0195979 A1
(43) Pub. Date: Jun. 22, 2023

(54) Intelligent decision-making method and system for maintaining urban underground sewer network

(71) Applicant: Zhengzhou University, Zhengzhou (CN)

(72) Inventors: Hongyuan Fang, Zhengzhou City (CN); Danyang Di, Zhengzhou City (CN); Bin Sun, Zhengzhou City (CN); Jinping Zhang, Zhengzhou City (CN); Bin Li, Zhengzhou City (CN); Haobang Hu, Zhengzhou City (CN); Cheng Li, Zhengzhou City (CN); Chaoyang Zhang, Zhengzhou City (CN)

(21) Appl. No.: 18/110,370

(22) Filed: Feb. 16, 2023

(30) Foreign Application Priority Data
Jun. 20, 2022 (CN) 202210697012.9

(51) Int. Cl. G06F 30/28

(52) U.S. Cl. CPC G06F 30/28

(57) ABSTRACT

An intelligent decision-making method for maintaining urban underground sewer network includes steps of: analyzing with a sewer network functional defect three-dimensional instantaneous hydraulic model; calibrating parameters by finite element fitting analysis and full-scale test, and verifying accuracy of the sewer network functional defect three-dimensional instantaneous hydraulic model; combining node water level iteration method, Preissmann slit method, Godunov finite volume method and unstructured grid to rebuild a surface-subsurface one-two-dimensional coupled connection model; using R language, dynamic library linking technology, and long-short-term memory neural network method of multi-source data samples for engineering secondary development of the surface-subsurface one-two-dimensional coupled connection model, and obtaining urban sewer network functional defect conditions with waterlogging result labels; and establishing a multi-objective planning intelligent decision-making model for sewer network maintenance and a solving method thereof. The present invention provides intelligent, accurate and scientific management for urban sewer network.

### CROSS REFERENCE OF RELATED APPLICATION

The present invention claims priority under 35 U.S.C. 119(a-d) to CN 202210697012.9, filed Jun. 20, 2022.

### BACKGROUND OF THE PRESENT INVENTION

### Field of Invention

The present invention relates to the technical field of pipeline network maintenance, and more particularly to an intelligent decision-making method and system for maintaining urban underground sewer network.

### Description of Related Arts

Due to global climate change, Chinese urban waterlogging problems caused by functional defects of sewer pipelines have become more frequent and more intense in recent years, seriously affecting the lives of urban residents. Casualties appeared during almost every major waterlogging, which seriously threatened the lives and properties of people, restricting the economic and social development of the entire city. Therefore, it is necessary to study the relationship between sewer pipeline functional defects and waterlogging.

Referring to the prior art, research on the relationship between sewer pipeline functional defects and waterlogging in China did not take into account the multi-phase flow mutual feed relationships of functional defects, water flow, and upper air, as well as the coupling of multiple fields such as gravity field, stress field, and flow field on the pipeline discharge coefficient. “Solid-liquid-gas” multiphase flow and multi-field coupling can change the instantaneous state of pipeline confluence and the parameter values of 1D and 2D models of surface and groundwater flow. In addition, due to the heavy workload, it is difficult to analyze and calculate the corresponding relationship between pipeline functional defects and waterlogging areas one by one through the control variable method. The above facts lead to the low accuracy of conventional decision-making system of urban waterlogging early warning and disaster prevention. Chinese patent CN110298076A provided an intelligent modeling and analyzing method for urban waterlogging based on GIS and SWMM, including building a simulation system based on GIS and SWMM; automatically preprocessing the model data and automatically identifying topological errors; calculating the hydrological and hydrodynamic coupling model based on SWMM while considering rainfall, so as to calculate the amount of rainwater confluent into the sewer network system; simulating the real-time information in the sewer network, and obtaining the overflow data of pipe points; analyzing the surface water inundation according to the overflow data of the pipe points, in such a manner that the surface water is simulated to obtain the depth of the surface water, and the surface water flow is distributed based on the window method; performing early warning analysis of the surface water and waterlogging, comprehensively considering the prediction of the surface water; based on the calculation results of the hydrological and hydrodynamic coupling model, automatically classifying the waterlogging risk levels in different areas according to the results of surface water inundation analysis, and providing an early warning plan for sewer and waterlogging emergency. This patent was mainly aimed at the research of surface water, thereby performing calculation and prediction based on the hydrological hydrodynamic coupling model. The factors involved are relatively simple, and it is hard to guarantee the accuracy of the obtained results.

Therefore, it is urgent in the art to provide a method and system that can take the multiphase flow and multi-field coupling into account to discover the influence of pipeline functional defects on the hydrology and hydrodynamics of urban waterlogging, and can make intelligent decisions accurately and efficiently.

### SUMMARY OF THE PRESENT INVENTION

Aiming at the deficiencies of the prior art, an object of the present invention is to provide an intelligent decision-making method for maintaining urban underground sewer network, so as to solve the problems that the prior art cannot take the multiphase flow and multi-field coupling into account to discover the influence of pipeline functional defects on the hydrology and hydrodynamics of urban waterlogging, and cannot make intelligent decisions accurately and efficiently. In addition, the present invention also provides an intelligent decision-making system for maintaining urban underground sewer network.

Accordingly, in order to accomplish the above objects, the present invention provides the following schemes.

First, the present invention provides an intelligent decision-making method for maintaining urban underground sewer network, comprising steps of:

S10, based on fluid dynamics and “mass-momentum-energy” conservation theory, analyzing with a sewer network functional defect three-dimensional instantaneous hydraulic model;

S20, calibrating parameters by finite element fitting analysis and full-scale test, and verifying accuracy of the sewer network functional defect three-dimensional instantaneous hydraulic model;

S30, combining a node water level iteration method, a Preissmann slit method, a Godunov finite volume method and an unstructured grid to rebuild a surface-subsurface one-two-dimensional coupled connection model;

S40, using an R language, a dynamic library linking technology, and a long-short-term memory neural network method of multi-source data samples for engineering secondary development of the surface-subsurface one-two-dimensional coupled connection model, and obtaining urban sewer network functional defect conditions with waterlogging result labels; and

S50, introducing a deep small-world neural network, a genetic algorithm and a simulated annealing algorithm to establish a multi-objective planning intelligent decision-making model for sewer network maintenance and a solving method of the multi-objective planning intelligent decision-making model.

Preferably, in the step S10, analyzing with the sewer network functional defect three-dimensional instantaneous hydraulic model comprises specific steps of:

S101, according to incompressibility of water flow and principle of volume conservation, obtaining a time-average motion equation and a pulsation motion equation

$$\{ \begin{matrix}\frac{\partial u}{\partial x} + \frac{\partial v}{\partial z} + \frac{\partial w}{\partial y} = 0 \\ \frac{\partial \overline{u}}{\partial x} + \frac{\partial \overline{v}}{\partial z} + \frac{\partial \overline{w}}{\partial y} = 0\end{matrix} ;$$

and

S102, combining “mass-momentum-energy” conservation equations

$$\{ \begin{matrix}\frac{d}{dt} {\int }_{V} {ρ}^{α} dV = - {\int }_{{Γ}_{V}} {ρ}^{α} {v}_{α} \cdot ndS + {\int }_{V} {Q}^{α} dV \\ \frac{d}{dt} {\int }_{V} {ρ}^{α} {v}_{α} dV = - {\int }_{{Γ}_{V}} {ρ}^{α} {v}_{α} ( {v}_{α} \cdot n ) dS + {\int }_{{Γ}_{V}} {σ}^{α} \cdot ndS + {\int }_{V} {ρ}^{α} {b}_{α} dV + {\int }_{V} {\hat{π}}^{α} dV \\ \frac{d}{dt} {\int }_{V} ( {ρ}^{α} {c}_{α} {T}_{α} ) dV = - {\int }_{{Γ}_{V}} {q}^{α} \cdot ndS + {\int }_{V} {Q}_{T}^{′ α} dV + {\int }_{V} {\hat{ε}}^{α} dV\end{matrix}$$

to construct a “solid-liquid-gas” spatial distribution model and obtain sewer network functional defect indexes; wherein u, v and w are respectively components of a vertical average flow velocity of a river section on x, y and z axes in a three-dimensional coordinate system; ū, v̅ and w̅ are real-time pulsating velocities of turbulent flow on the three axes; V is a volume of any given space in a pipeline, and Γᵥ is a boundary of a space domain; α is 1, 2 or 3, which represents a solid phase, a liquid phase or a gas phase respectively; v_{α} is a velocity of the phase α, Q^{α} is a source term of the phase α, and ρ^{α} is a density of the phase α; n is a normal vector of the space domain boundary Γᵥ, and \hat{π}^{α} is another source item relative to the phase α; σ^{α} is a stress tensor; b_{α} is a body force; S is a cross-sectional area of the space domain boundary Γᵥ; c_{α} is a specific heat capacity of the phase α, T_{α} is a temperature of the phase α, and Q_{T}^{′α} is a heat source of the phase α; \hat{ε}^{α} is a heat source for the phase α, which is generated by phase transition of other phases.

Preferably, in the step S20, the finite element fitting analysis comprises steps of: using Abaqus software to construct a “solid-liquid-gas” multiphase flow simulation model of the sewer network functional defects, and verifying the parameters calibrated by the full-scale test and a theoretical structural formula obtained by the sewer network functional defect three-dimensional instantaneous hydraulic model; wherein the full-scale test refers to construction of landing wells, scour gates and functional defect pipe sections, and accurate values of pipeline confluence instantaneous state parameters are calculated according to the theoretical structural formula.

Preferably, in the step S40, engineering the secondary development of the surface-subsurface one-two-dimensional coupled connection model comprises steps of:

S401, based on rain and flood analysis software InforWorks ICM, using the dynamic library linking technology and an R language secondary development technology to re-implement and embed the surface-subsurface one-two-dimensional coupled connection model into the InforWorks ICM, thereby optimizing the InforWorks ICM; and

S402, performing the secondary development to optimized InforWorks ICM based on the InforWorks ICM, a “solid-liquid-gas” multiphase flow movement law model of the sewer network functional defects, a section confluence state model, a section instantaneous velocity and flow model, and the surface-subsurface one-two-dimensional coupled connection model, so as to improve and upgrade the InforWorks ICM, thereby outputting urban waterlogging losses under different sewer network functional defect conditions.

Preferably, in the step S50, the solving method of the multi-objective planning intelligent decision-making model comprises steps of: using a genetic algorithm and a simulated annealing algorithm for intelligent optimization, so as to obtain the urban sewer network functional defect conditions with maintenance decision labels; using the urban sewer network functional defect conditions with the maintenance decision labels as initial input data of the deep small-world neural network; after clustering, outlier detection and interpolation processing, repeatedly training and adjusting a multi-layer restricted Boltzmann machine of the deep small-world neural network through data set expansion, thereby obtaining intelligent decision-making results for urban sewer network maintenance, wherein the intelligent decision-making results are dynamically adjusted with time and rainstorm with different return periods.

Preferably, in the step S30, the surface-subsurface one-two-dimensional coupled connection model is formed by a one-dimensional sewer network open and full flow model and a two-dimensional surface water flow model coupled in both a horizontal direction and a vertical direction; relevant structural formulas of the one-dimensional sewer network open and full flow model and the two-dimensional surface water flow model are obtained through analysis with a weir flow formula method, a mutual boundary method and a fixed node water level method.

Second, the present invention provides an intelligent decision-making system for maintaining urban underground sewer network, comprising:

a functional defect periodic detection subsystem for an urban sewer network in operation;

a sewer network maintenance intelligent decision-making comprehensive management database;

a sewer network maintenance plan management subsystem; and

a sewer network maintenance intelligent decision-making evaluation subsystem.

Preferably, the functional defect periodic detection subsystem for the urban sewer network in operation comprises an ultrasonic detection robot based on an Internet of Things/base station data transmission technology, a video surveillance detector, a pipeline detection robot, a magnetic flux detector, and a sewer network functional defect detection data acquisition workstation; the sewer network maintenance intelligent decision-making comprehensive management database provides access and control functions of real-time rainstorm data of different return periods, sewer network maintenance costs, real-time collection of maintenance information, and geographic information data of sewer network functional defects to top application layer users; the sewer network maintenance plan management subsystem comprises maintenance and operation execution plans, work order execution and receipt, and work order data update; the sewer network maintenance intelligent decision-making evaluation subsystem comprises a sewer network functional defect three-dimensional instantaneous hydraulic analysis module, a finite element full-scale test module, the surface-subsurface one-two-dimensional coupled connection model, a rain and flood model engineering module, and a multi-objective planning decision-making and solving module.

Preferably, a system structure of the intelligent decision-making system is divided into a data access control layer, an access control service layer and an application layer; a comprehensive management database server in the data access control layer is connected to a geographic information system server and a software standard data interface; the access control service layer is carried by the geographic information system server, and provides geographic information system services, business query and operation services, computing services, and database access and relay access control services for the application layer; the application layer uses a hybrid architecture model formed by a C/S business system and a B/S business system.

Preferably, a hardware support platform of the intelligent decision-making system comprises a comprehensive management database server, an urban sewer network geographic information system server, a sewer network functional defect detection data acquisition workstation, a sewer network maintenance plan execution agency workstation, a sewer network maintenance plan real-time execution status collection workstation, an urban sewer network maintenance authority monitoring and decision-making workstation, a regional sewer network maintenance authority monitoring and decision-making workstation, and subordinate detection and maintenance instruments, meters, and sensors connected through Internet of Things/base stations.

Compared with the prior art, the intelligent decision-making method and system for maintaining the urban underground sewer network provided by the present invention have at least the following beneficial effects.

The present invention constructs an urban surface-subsurface one-two-dimensional coupled connection model under the action of multi-phase flow and multi-field coupling, which takes the evolution law of the instantaneous state of pipeline water flow. The present invention also uses engineering technical means for secondary development and realization of InforWorks ICM, so that it can accurately reveal the hydrological and hydrodynamic coupling mechanisms between the sewer network functional defects and urban waterlogging. The present invention establishes the intelligent decision-making method for maintaining the urban sewer network based on multi-objective decision-making and deep small-world neural network, and establishes the intelligent decision-making system for maintaining the urban sewer network, which can accurately and efficiently identify the corresponding relationship between the sewer network functional defects and the waterlogging losses, and provide rational decision-making. The present invention integrates software and hardware to construct the intelligent decision-making system for maintaining the urban sewer network, so as to provide a maintenance decision-making platform with integrated sewer network functional defect data collection, parameter calibration, secondary development and intelligent optimization. Based on a mixed mode formed by C/S and B/S service modes, the geographic information system server and the comprehensive database server are used as a data processing platform, and fluid dynamics, full-scale test, multi-objective decision-making and genetic/simulated annealing algorithms are used as an analysis method, thereby performing the design and development of the intelligent decision-making system for maintaining the urban sewer network. The present invention not only meets the system speed requirements of complex data processing, but also ensures the accuracy of the maintenance decision-making results, thus solving the problem of intelligent and precise preventive maintenance of urban waterlogging point sewer network while considering the coupling effects of pipeline functional defects and waterlogging under multi-objective constraints.

### BRIEF DESCRIPTION OF THE DRAWINGS

In order to illustrate the solution of the present invention more clearly, the drawings that involved in the embodiments will be briefly described below. Obviously, the accompanying drawings only illustrate some embodiments of the present invention. For those skilled in the art, other drawings can also be obtained based on these drawings without paying creative work.

FIG. 1 is a flow chart of an intelligent decision-making method for maintaining urban sewer network according to an embodiment of the present invention;

FIG. 2 is the general block diagram of an intelligent decision-making system for maintaining urban sewer network according to the embodiment of the present invention; and

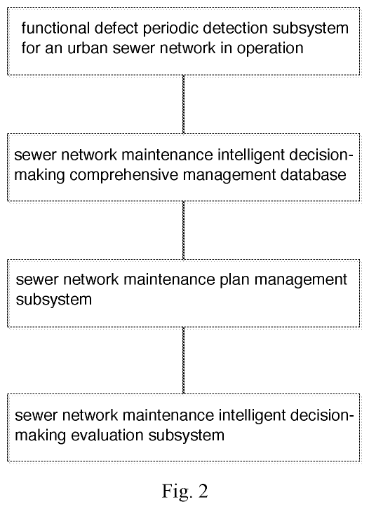

FIG. 3 is a detailed composition diagram of a data access control layer, an access control service layer and an application layer of the intelligent decision-making system according to the embodiment of the present invention.

### DETAILED DESCRIPTION OF THE PREFERRED EMBODIMENT

Unless otherwise defined, all technical and scientific terms used herein have the same meaning as commonly understood by those skilled in the art. The terms used in the specification herein are only exemplary, and are not intended to be limiting. For example, the terms “length”, “width”, “upper”, “lower”, “left”, “right”, “front”, “rear”, “vertical”, “horizontal”, “top”, “bottom”, “inner”, “outer” and other orientation or position indicators are based on the orientations or positions shown in the drawings, which are only for convenience of description and cannot be understood as limitations on the technical solution.

The terms “include” and “comprise” in the specification and claims of the present invention and the description of the above drawings, as well as any variations thereof, are intended to cover a non-exclusive inclusion. The terms “first”, “second”, etc. are used to distinguish different objects, not to describe a specific order. In the specification and claims of the present invention and the above description of the drawings, when an element is referred to as being “fixed” or “mounted” or “disposed on” or “connected to” another element, it may be directly or indirectly on the other element. For example, when an element is referred to as being “connected to” another element, it can be directly or indirectly connected to the other element.

Furthermore, “embodiment” herein means that a particular feature, structure, or characteristic described can be included in at least one embodiment of the present invention. The occurrences of this phrase in various places in the specification are not necessarily all referring to the same embodiment, nor are separate or alternative embodiments mutually exclusive of other embodiments. It is understood explicitly and implicitly by those skilled in the art that the embodiment described herein can be combined with other embodiments.

The present invention provides an intelligent decision-making method for maintaining urban underground sewer network, which can be applied to research work on relationships between sewer functional defects and waterlogging, and comprises steps of: S10, based on fluid dynamics and “mass-momentum-energy” conservation theory, analyzing with a sewer network functional defect three-dimensional instantaneous hydraulic model; S20, calibrating parameters by finite element fitting analysis and full-scale test, and verifying accuracy of the sewer network functional defect three-dimensional instantaneous hydraulic model; S30, combining a node water level iteration method, a Preissmann slit method, a Godunov finite volume method and an unstructured grid to rebuild a surface-subsurface one-two-dimensional coupled connection model; S40, using an R language, a dynamic library linking technology, and a long-short-term memory neural network method of multi-source data samples for engineering secondary development of the surface-subsurface one-two-dimensional coupled connection model, and obtaining urban sewer network functional defect conditions with waterlogging result labels; and S50, introducing a deep small-world neural network, a genetic algorithm and a simulated annealing algorithm to establish a multi-objective planning intelligent decision-making model for sewer network maintenance and a solving method of the multi-objective planning intelligent decision-making model.

The present invention can provide intelligent, accurate and scientific management and decision-making for urban underground sewer network.

In order to make schemes of the present invention clearer to those skilled in the art, the technical solutions in the embodiment of the present invention will be clearly and completely described below in conjunction with the accompanying drawings.

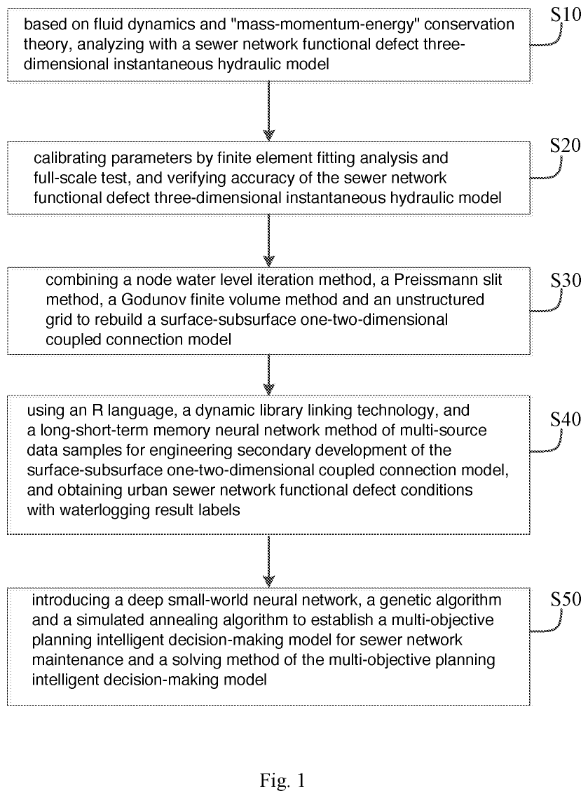

The present invention provides an intelligent decision-making method for maintaining urban underground sewer network, which can be applied to research work on relationships between sewer functional defects and waterlogging. Referring to FIG. 1, the intelligent decision-making method comprises steps of:

S10, based on fluid dynamics and “mass-momentum-energy” conservation theory, analyzing with a sewer network functional defect three-dimensional instantaneous hydraulic model;

S20, calibrating parameters by finite element fitting analysis and full-scale test, and verifying accuracy of the sewer network functional defect three-dimensional instantaneous hydraulic model;

S30, combining a node water level iteration method, a Preissmann slit method, a Godunov finite volume method and an unstructured grid to rebuild a surface-subsurface one-two-dimensional coupled connection model;

S40, using an R language, a dynamic library linking technology, and a long-short-term memory neural network method of multi-source data samples for engineering secondary development of the surface-subsurface one-two-dimensional coupled connection model, and obtaining urban sewer network functional defect conditions with waterlogging result labels; and

S50, introducing a deep small-world neural network, a genetic algorithm and a simulated annealing algorithm to establish a multi-objective planning intelligent decision-making model for sewer network maintenance and a solving method of the multi-objective planning intelligent decision-making model.

Preferably, according to the embodiment, sewer network functional defect three-dimensional instantaneous hydraulic model analysis in the step S10 is theoretically derived from the perspective of multiphase flow and multi-field, wherein a liquid phase stress tensor and shear viscosity spatial distribution model, a solid phase stress tensor and shear viscosity spatial distribution model, and a gas phase Newtonian viscous stress spatial distribution model under joint actions of gravity field, pressure field, stress field and flow field are respectively constructed.

Preferably, according to the embodiment, construction of the liquid phase stress tensor and shear viscosity spatial distribution model, the solid phase stress tensor and shear viscosity spatial distribution model, and the gas phase Newtonian viscous stress spatial distribution model comprises steps of:

S101, according to incompressibility of water flow and principle of volume conservation, obtaining a time-average motion equation and a pulsation motion equation

$$\{ \begin{matrix}\frac{\partial u}{\partial x} + \frac{\partial v}{\partial z} + \frac{\partial w}{\partial y} = 0 \\ \frac{\partial \overline{u}}{\partial x} + \frac{\partial \overline{v}}{\partial z} + \frac{\partial \overline{w}}{\partial y} = 0\end{matrix} ;$$

and

S102, combining “mass-momentum-energy” conservation equations

$$\{ \begin{matrix}\frac{d}{dt} {\int }_{V} {ρ}^{α} dV = - {\int }_{{Γ}_{V}} {ρ}^{α} {v}_{α} \cdot ndS + {\int }_{V} {Q}^{α} dV \\ \frac{d}{dt} {\int }_{V} {ρ}^{α} {v}_{α} dV = - {\int }_{{Γ}_{V}} {ρ}^{α} {v}_{α} ( {v}_{α} \cdot n ) dS + {\int }_{{Γ}_{V}} {σ}^{α} \cdot ndS + {\int }_{V} {ρ}^{α} {b}_{α} dV + {\int }_{V} {\hat{π}}^{α} dV \\ \frac{d}{dt} {\int }_{V} ( {ρ}^{α} {c}_{α} {T}_{α} ) dV = - {\int }_{{Γ}_{V}} {q}^{α} \cdot ndS + {\int }_{V} {Q}_{T}^{′ α} dV + {\int }_{V} {\hat{ε}}^{α} dV\end{matrix}$$

to construct a “solid-liquid-gas” spatial distribution model and obtain sewer network functional defect indexes; wherein u, v and w are respectively components of a vertical average flow velocity of a river section on x, y and z axes in a three-dimensional coordinate system; ū, v̅ and w̅ are real-time pulsating velocities of turbulent flow on the three axes; V is a volume of any given space in a pipeline, and Γᵥ is a boundary of a space domain; α is 1, 2 or 3, which represents a solid phase, a liquid phase or a gas phase respectively; v_{α} is a velocity of the phase α, Q^{α} is a source term of the phase α, and ρ^{α} is a density of the phase α; n is a normal vector of the space domain boundary Γᵥ, and \hat{π}^{α} is another source item relative to the phase α; σ^{α} is a stress tensor; b_{α} is a body force; S is a cross-sectional area of the space domain boundary Γᵥ; c_{α} is a specific heat capacity of the phase α, T_{α} is a temperature of the phase α, and Q_{T}^{′α} is a heat source of the phase α; \hat{ε}^{α} is a heat source for the phase α, which is generated by phase transition of other phases.

Preferably, according to the embodiment, the sewer network functional defect three-dimensional instantaneous hydraulic model analysis can obtain pulsation period change of the average flow velocity and the instantaneous flow velocity between typical sections under the action of gravity flow and pressure flow, turbulent intensity distribution, energy dissipation law, and pipe Reynolds stress distribution, thereby accurately solving the critical start-up conditions of sewer network functional defects, moving distance of moving mass, and the theoretical structural formulas of flow capacity, as well as extracting and analyzing the discharge coefficient and turbulent flow field structural parameters related to the sewer functional defects.

Preferably, according to the embodiment, in the step S20, the finite element fitting analysis comprises steps of: using Abaqus software to construct a “solid-liquid-gas” multiphase flow simulation model of the sewer network functional defects, and verifying the parameters calibrated by the full-scale test and a theoretical structural formula obtained by the sewer network functional defect three-dimensional instantaneous hydraulic model; wherein the full-scale test refers to construction of landing wells, scour gates and functional defect pipe sections, and accurate values of pipeline confluence instantaneous state parameters are calculated according to fluid dynamics, sensors and the theoretical structural formula of the three-dimensional instantaneous hydraulic model. The full-scale test consists of four parts: a sewer functional defect scene adjustment module, a confluence parameter spatio-temporal variation analysis module, a mass transport analysis module, and a pipeline flow velocity and flow time variation analysis module.

Preferably, according to the embodiment, in the step S30, the surface-subsurface one-two-dimensional coupled connection model is formed by a one-dimensional sewer network open and full flow model and a two-dimensional surface water flow model coupled in both a horizontal direction (surface) and a vertical (subsurface) direction; relevant structural formulas of the one-dimensional sewer network open and full flow model and the two-dimensional surface water flow model are obtained through analysis with a weir flow formula method, a mutual boundary method and a fixed node water level method.

Preferably, according to the embodiment, in the step S40, engineering the secondary development of the surface-subsurface one-two-dimensional coupled connection model comprises steps of: based on the most developed rain and flood analysis software InforWorks ICM, using the dynamic library linking technology and an R language secondary development technology to re-implement and embed the surface-subsurface one-two-dimensional coupled connection model which considers an coupling effect of sewer functional defects and urban waterlogging into the InforWorks ICM, thereby optimizing the InforWorks ICM; and performing the secondary development to optimized InforWorks ICM based on the InforWorks ICM, a “solid-liquid-gas” multiphase flow movement law model of the sewer network functional defects, a section confluence state model, a section instantaneous velocity and flow model, and the surface-subsurface one-two-dimensional coupled connection model, so as to improve and upgrade the InforWorks ICM, thereby outputting urban waterlogging losses under different sewer network functional defect conditions.

Preferably, according to the embodiment, in the step S50, the solving method of the multi-objective planning intelligent decision-making model comprises steps of: using a genetic algorithm and a simulated annealing algorithm for intelligent optimization, so as to obtain the urban sewer network functional defect conditions with maintenance decision labels; using the urban sewer network functional defect conditions with the maintenance decision labels as initial input data of the deep small-world neural network; after clustering, outlier detection and interpolation processing, repeatedly training and adjusting a multi-layer restricted Boltzmann machine of the deep small-world neural network through data set expansion, thereby obtaining intelligent decision-making results for urban sewer network maintenance, wherein the intelligent decision-making results are dynamically adjusted with time and rainstorm with different return periods.

Specifically, the deep small-world neural network (DSWNN) consists of two stages: offline learning and online decision-making, which comprises steps of:

S501, obtaining multi-dimensional index data such as type, degree, and dredging/cleaning cost of the sewer network functional defects at each important node with the help of the Internet of Things/base station and a local area network of an urban sewer network online operation and maintenance system, comprising normal collection data, abnormal or man-made larger-scale maliciously tampered sample data, and data processing through index screening, anomaly detection and interpolation;

S502, intercepting all the sample data with a sliding window of a certain length to obtain a mean subsequence under the sliding window; forming all the subsequences into a training sample set, and labeling the training sample set according to InforWorks ICM numerical simulation results and multi-objective planning results of sewer network maintenance, which mainly classifies urban sewer network functional defect training sample nodes that need to be maintained;

S503, using unlabeled data set to pre-train the multi-layer restricted Boltzmann machine (RBM) network of the deep small-world neural network (DSWNN); after obtaining full feature representation, recording network parameters including weight and bias of neurons;

S504, randomly adding edges to the multi-layer restricted Boltzmann machine (RBM) network according to a random edge probability p of the deep small-world neural network (DSWNN), and adding a fully connected classification layer on a top layer to convert it into a deep small-world neural network (DSWNN) with a multi-classification function; training the network again with supervised learning, and using a back propagation (BP) algorithm to fine-tune parameters until the training is completed, thereby getting a trained deep small-world neural network (DSWNN) classifier model;

S505, collecting a functional defect index set of the urban sewer network online, and processing the online data with the same sliding window as that used in the training to obtain test samples; and

S506, inputting the test samples into the trained deep small-world neural network (DSWNN) classifier model to obtain the intelligent decision-making result and optimal response strategy for the sewer network maintenance, thereby complete the optimization of intelligent decision-making management for maintaining the urban underground sewer network.

The intelligent decision-making method for maintaining the urban underground sewer network described in the above-mentioned embodiment adopts advanced fluid dynamics, “mass-momentum-energy” conservation theory, finite element high-precision fitting and full-scale test method, node water level iteration method, Preissmann slit method, Godunov finite volume method and unstructured grid, R language, dynamic library linking technology and long-short memory neural network method of multi-source data samples, deep small-world neural network, genetic algorithm and simulated annealing algorithm, which optimizes and improvs relevant links and details of the urban underground sewer network maintenance, couples the hydrological and hydrodynamic relationship between sewer functional defects and urban waterlogging, makes full use the technical route of “theoretical analysis-test calibration and verification-model construction-optimization decision-making and solution” to provide strong technical support for intelligent management and decision-making of urban sewer network maintenance, and provides intelligent, accurate and scientific management and decision-making for most urban underground sewer networks.

The present invention also provides an intelligent decision-making system for maintaining urban underground sewer network, comprising:

a functional defect periodic detection subsystem for an urban sewer network in operation; wherein the functional defect periodic detection subsystem for the urban sewer network in operation comprises an ultrasonic detection robot based on an Internet of Things/base station data transmission technology, a video surveillance detector, a pipeline detection robot, a magnetic flux detector, and a sewer network functional defect detection data acquisition workstation;

a sewer network maintenance intelligent decision-making comprehensive management database; wherein the sewer network maintenance intelligent decision-making comprehensive management database provides access and control functions of real-time rainstorm data of different return periods, sewer network maintenance costs, real-time collection of maintenance information, and geographic information data of sewer network functional defects to top application layer users;

a sewer network maintenance plan management subsystem; wherein the sewer network maintenance plan management subsystem comprises maintenance and operation execution plans, work order execution and receipt, and work order data update; the maintenance and operation execution plans for the sewer network functional defects comprises three strategies: sewer network overall expansion, dredging of sedimentation, and cleaning of scaling bodies; the work order data update refers to sending a current implementation condition of a sewer network maintenance strategy to the comprehensive management database, and using it as an initial input of the next intelligent decision-making evaluation subsystem to improve accuracy of maintenance decisions; and

a sewer network maintenance intelligent decision-making evaluation subsystem; wherein the sewer network maintenance intelligent decision-making evaluation subsystem comprises a sewer network functional defect three-dimensional instantaneous hydraulic analysis module, a finite element full-scale test module, the surface-subsurface one-two-dimensional coupled connection model, a rain and flood model engineering module, and a multi-objective planning decision-making and solving module.

Preferably, according to the embodiment, the intelligent decision-making system for maintaining the urban underground sewer network is formed by software and a hardware support platform:

the hardware support platform comprises a comprehensive management database server, an urban sewer network GIS server, a sewer network functional defect detection data acquisition workstation, a sewer network maintenance plan execution agency workstation, a sewer network maintenance plan real-time execution status collection workstation, an urban sewer network maintenance authority monitoring and decision-making workstation, a regional sewer network maintenance authority monitoring and decision-making workstation, and subordinate detection and maintenance instruments, meters, and sensors connected through Internet of Things/base stations; and

the software comprises code implementation of functional modules such as sewer network maintenance cost statistics, deep small-world neural network algorithm, multi-objective decision-making for sewer network maintenance, and urban sewer network functional defect statistics platform, wherein the software runs on the hardware support platform.

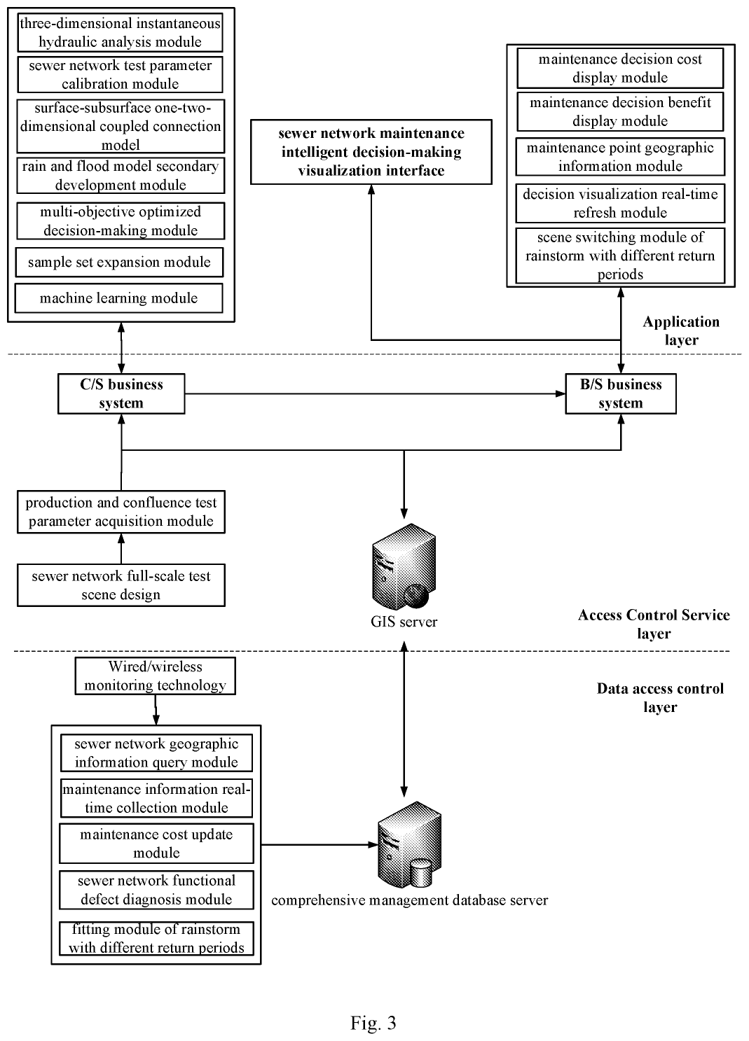

Referring to FIG. 3, a system structure of the intelligent decision-making system is divided into a data access control layer, an access control service layer and an application layer.

A comprehensive management database server in the data access control layer is connected to a geographic information system (GIS) server and a software standard data interface.

Functional items corresponding to the software standard data interface comprises a sewer network geographic information query module, a maintenance information real-time collection module, a maintenance cost update module, a sewer network functional defect diagnosis module, and a fitting module of rainstorm with different return periods.

The functional items corresponding to the software standard data interface are obtained with the support of a wired/wireless monitoring technology.

The access control service layer is carried by the GIS server, and provides GIS services, business query and operation services, computing services, and database access and relay access control services for the application layer.

The GIS service refers to providing geographical information interaction related services for intelligent decision-making of upper-level urban sewer network maintenance.

The business query and operation services comprise a client/server (C/S) business system and a browser/server (B/S) business system.

The calculation services refer to providing complex data analysis and processing of the three-dimensional instantaneous hydraulic analysis module, sewer network test parameter calibration module, surface-subsurface one-two-dimensional coupled connection model, rain and flood model secondary development module, multi-objective optimized decision-making module, sample set expansion module, machine learning module, and production and confluence test parameter acquisition module to the application layer through the C/S business system; as well as providing complex data analysis and processing of maintenance decision cost display module, maintenance decision benefit display module, maintenance point geographic information module, decision visualization real-time refresh module, scene switching module of rainstorm with different return periods, and sewer network maintenance intelligent decision-making visualization interface to the application layer through the B/S business system.

Basic test conditions for the production and confluence test parameter acquisition module are provided by sewer network full-scale test scene design.

The database access and relay access control services refer to that the application layer implements real-time access control of data and parameters related to the intelligent decision-making of the sewer pipe network maintenance through a GIS server relay access comprehensive management database server.

The application layer uses a hybrid architecture model formed by a C/S business system and a B/S business system, comprising: three-dimensional instantaneous hydraulic analysis module, sewer network test parameter calibration module, surface-subsurface one-two-dimensional coupled connection model, rain and flood model secondary development module, multi-objective optimized decision-making module, sample set expansion module, machine learning module, and production and confluence test parameter acquisition module to the application layer through the C/S business system; as well as maintenance decision cost display module, maintenance decision benefit display module, maintenance point geographic information module, decision visualization real-time refresh module, scene switching module of rainstorm with different return periods, and sewer network maintenance intelligent decision-making visualization interface provided by the B/S business system.

The sewer network maintenance intelligent decision-making visualization interface realizes the real-time visualization of user-end results through the B/S business system, and can issue intelligent decision-making commands to various sewer network maintenance departments in the city through the visual interface. The sewer network maintenance intelligent decision-making visualization interface periodically updates the decision-making results of the sewer network maintenance based on multi-objective decision-making output.

According to the embodiment, the system adopting the intelligent decision-making method for maintaining the urban sewer network is a complex giant system involving fluid dynamics theory, “mass-momentum-energy” conservation theory, full-scale test method, secondary development technology, dynamic link technology, deep learning technology, database technology, geographic information system, automatic data collection technology, middleware technology, network technology and system integration technology. The system provides a maintenance decision-making platform with integrated sewer network functional defect data collection, parameter calibration, secondary development and intelligent optimization. Based on a mixed mode formed by C/S and B/S service modes, the geographic information system server and the comprehensive database server are used as a data processing platform, and fluid dynamics, full-scale test, multi-objective decision-making and genetic/simulated annealing algorithms are used as an analysis method, thereby performing the design and development of the intelligent decision-making system for maintaining the urban sewer network. The present invention not only meets the system speed requirements of complex data processing, but also ensures the accuracy of the maintenance decision-making results, thus solving the problem of intelligent and precise preventive maintenance of urban waterlogging point sewer network while considering the coupling effects of pipeline functional defects and waterlogging under multi-objective constraints.

Apparently, the embodiment described above is only one of the preferred embodiments of the present invention, not all of them. The accompanying drawings illustrate the embodiment of the present invention, but are not limiting. The present invention can be embodied in many different forms, while the above embodiment is provided so that the disclosure of the present invention will be more thorough. Although the present invention has been described in detail with reference to the foregoing embodiment, those skilled in the art can still modify the technical schemes described in the foregoing embodiment, or perform equivalent replacements for some of the technical features. All equivalent structures made with the content of the description and drawings of the present invention, which may directly or indirectly used in other related technical fields, are also within the protection scope of the present invention.

What is claimed is:

1. An intelligent decision-making method for maintaining urban underground sewer network, comprising steps of:
S10, based on fluid dynamics and “mass-momentum-energy” conservation theory, analyzing with a sewer network functional defect three-dimensional instantaneous hydraulic model;
S20, calibrating parameters by finite element fitting analysis and full-scale test, and verifying accuracy of the sewer network functional defect three-dimensional instantaneous hydraulic model;
S30, combining a node water level iteration method, a Preissmann slit method, a Godunov finite volume method and an unstructured grid to rebuild a surface-subsurface one-two-dimensional coupled connection model;
S40, using an R language, a dynamic library linking technology, and a long-short-term memory neural network method of multi-source data samples for engineering secondary development of the surface-subsurface one-two-dimensional coupled connection model, and obtaining urban sewer network functional defect conditions with waterlogging result labels; and
S50, introducing a deep small-world neural network, a genetic algorithm and a simulated annealing algorithm to establish a multi-objective planning intelligent decision-making model for sewer network maintenance and a solving method of the multi-objective planning intelligent decision-making model.

2. The intelligent decision-making method, as recited in claim 1, wherein in the step S10, analyzing with the sewer network functional defect three-dimensional instantaneous hydraulic model comprises specific steps of:
S101, according to incompressibility of water flow and principle of volume conservation, obtaining a time-average motion equation and a pulsation motion equation
$$\{ \begin{matrix}\frac{\partial u}{\partial x} + \frac{\partial v}{\partial z} + \frac{\partial w}{\partial y} = 0 \\ \frac{\partial \overline{u}}{\partial x} + \frac{\partial \overline{v}}{\partial z} + \frac{\partial \overline{w}}{\partial y} = 0\end{matrix} ;$$
and
S102, combining “mass-momentum-energy” conservation equations
$$\{ \begin{matrix}\frac{d}{dt} {\int }_{V} {ρ}^{α} dV = - {\int }_{{Γ}_{V}} {ρ}^{α} {v}_{α} \cdot ndS + {\int }_{V} {Q}^{α} dV \\ \frac{d}{dt} {\int }_{V} {ρ}^{α} {v}_{α} dV = - {\int }_{{Γ}_{V}} {ρ}^{α} {v}_{α} ( {v}_{α} \cdot n ) dS + {\int }_{{Γ}_{V}} {σ}^{α} \cdot ndS + {\int }_{V} {ρ}^{α} {b}_{α} dV + {\int }_{V} {\hat{π}}^{α} dV \\ \frac{d}{dt} {\int }_{V} ( {ρ}^{α} {c}_{α} {T}_{α} ) dV = - {\int }_{{Γ}_{V}} {q}^{α} \cdot ndS + {\int }_{V} {Q}_{T}^{′ α} dV + {\int }_{V} {\hat{ε}}^{α} dV\end{matrix}$$
to construct a “solid-liquid-gas” spatial distribution model and obtain sewer network functional defect indexes; wherein u, v and w are respectively components of a vertical average flow velocity of a river section on x, y and z axes in a three-dimensional coordinate system; ū, v̅ and w̅; are real-time pulsating velocities of turbulent flow on the three axes; V is a volume of any given space in a pipeline, and Γᵥ is a boundary of a space domain; α is 1, 2 or 3, which represents a solid phase, a liquid phase or a gas phase respectively; v_{α} is a velocity of the phase α, Q^{α} is a source term of the phase α, and ρ^{α} is a density of the phase α; n is a normal vector of the space domain boundary Γᵥ, and \hat{π}^{α} is another source item relative to the phase α; σ^{α} is a stress tensor; b_{α} is a body force; S is a cross-sectional area of the space domain boundary Γᵥ; c_{α} is a specific heat capacity of the phase α, T_{α} is a temperature of the phase α, and Q_{T}^{′α} is a heat source of the phase α; \hat{ε}α is a heat source for the phase α, which is generated by phase transition of other phases.

3. The intelligent decision-making method, as recited in claim 2, wherein in the step S20, the finite element fitting analysis comprises steps of: using Abaqus software to construct a “solid-liquid-gas” multiphase flow simulation model of the sewer network functional defects, and verifying the parameters calibrated by the full-scale test and a theoretical structural formula obtained by the sewer network functional defect three-dimensional instantaneous hydraulic model; wherein the full-scale test refers to construction of landing wells, scour gates and functional defect pipe sections, and accurate values of pipeline confluence instantaneous state parameters are calculated according to the theoretical structural formula.

4. The intelligent decision-making method, as recited in claim 3, wherein in the step S40, engineering the secondary development of the surface-subsurface one-two-dimensional coupled connection model comprises steps of:
S401, based on rain and flood analysis software InforWorks ICM, using the dynamic library linking technology and an R language secondary development technology to re-implement and embed the surface-subsurface one-two-dimensional coupled connection model into the InforWorks ICM, thereby optimizing the InforWorks ICM; and
S402, performing the secondary development to optimized InforWorks ICM based on the InforWorks ICM, a “solid-liquid-gas” multiphase flow movement law model of the sewer network functional defects, a section confluence state model, a section instantaneous velocity and flow model, and the surface-subsurface one-two-dimensional coupled connection model, so as to improve and upgrade the InforWorks ICM, thereby outputting urban waterlogging losses under different sewer network functional defect conditions.

5. The intelligent decision-making method, as recited in claim 4, wherein in the step S50, the solving method of the multi-objective planning intelligent decision-making model comprises steps of: using a genetic algorithm and a simulated annealing algorithm for intelligent optimization, so as to obtain the urban sewer network functional defect conditions with maintenance decision labels; using the urban sewer network functional defect conditions with the maintenance decision labels as initial input data of the deep small-world neural network; after clustering, outlier detection and interpolation processing, repeatedly training and adjusting a multi-layer restricted Boltzmann machine of the deep small-world neural network through data set expansion, thereby obtaining intelligent decision-making results for urban sewer network maintenance, wherein the intelligent decision-making results are dynamically adjusted with time and rainstorm with different return periods.

6. The intelligent decision-making method, as recited in claim 5, wherein in the step S30, the surface-subsurface one-two-dimensional coupled connection model is formed by a one-dimensional sewer network open and full flow model and a two-dimensional surface water flow model coupled in both a horizontal direction and a vertical direction; relevant structural formulas of the one-dimensional sewer network open and full flow model and the two-dimensional surface water flow model are obtained through analysis with a weir flow formula method, a mutual boundary method and a fixed node water level method.

7. An intelligent decision-making system for maintaining urban underground sewer network, as recited in claim 1, comprising:
a functional defect periodic detection subsystem for an urban sewer network in operation;
a sewer network maintenance intelligent decision-making comprehensive management database;
a sewer network maintenance plan management subsystem; and
a sewer network maintenance intelligent decision-making evaluation subsystem.

8. The intelligent decision-making system, as recited in claim 7, wherein the functional defect periodic detection subsystem for the urban sewer network in operation comprises an ultrasonic detection robot based on an Internet of Things/base station data transmission technology, a video surveillance detector, a pipeline detection robot, a magnetic flux detector, and a sewer network functional defect detection data acquisition workstation; the sewer network maintenance intelligent decision-making comprehensive management database provides access and control functions of real-time rainstorm data of different return periods, sewer network maintenance costs, real-time collection of maintenance information, and geographic information data of sewer network functional defects to top application layer users; the sewer network maintenance plan management subsystem comprises maintenance and operation execution plans, work order execution and receipt, and work order data update; the sewer network maintenance intelligent decision-making evaluation subsystem comprises a sewer network functional defect three-dimensional instantaneous hydraulic analysis module, a finite element full-scale test module, the surface-subsurface one-two-dimensional coupled connection model, a rain and flood model engineering module, and a multi-objective planning decision-making and solving module.

9. The intelligent decision-making system, as recited in claim 7, wherein a system structure of the intelligent decision-making system is divided into a data access control layer, an access control service layer and an application layer; a comprehensive management database server in the data access control layer is connected to a geographic information system server and a software standard data interface; the access control service layer is carried by the geographic information system server, and provides geographic information system services, business query and operation services, computing services, and database access and relay access control services for the application layer; the application layer uses a hybrid architecture model formed by a C/S business system and a B/S business system.

10. The intelligent decision-making system, as recited in claim 7, wherein a hardware support platform of the intelligent decision-making system comprises a comprehensive management database server, an urban sewer network geographic information system server, a sewer network functional defect detection data acquisition workstation, a sewer network maintenance plan execution agency workstation, a sewer network maintenance plan real-time execution status collection workstation, an urban sewer network maintenance authority monitoring and decision-making workstation, a regional sewer network maintenance authority monitoring and decision-making workstation, and subordinate detection and maintenance instruments, meters, and sensors connected through Internet of Things/base stations.
